(19) United States
(12) Patent Application Publication
(10) Pub. No.: US 2021/0004383 A1
(43) Pub. Date: Jan. 7, 2021

(54) SYSTEM AND METHOD FOR ENABLING EXTRACT TRANSFORM AND LOAD PROCESSES IN A BUSINESS INTELLIGENCE SERVER

(71) Applicant: Oracle International Corporation, Redwood Shores, CA (US)

(72) Inventors: RAGHURAM VENKATASUBRAMANIAN, CUPERTINO, CA (US); ROGER BOLSIUS, ROUND ROCK, TX (US); HARVARD PAN, BOSTON, MA (US); ALEXTAIR MASCARENHAS, FOSTER CITY, CA (US); SAUGATA CHOWDHURY, SUNNYVALE, CA (US); VENUGOPAL SURENDRAN, SANTA CLARA, CA (US); ANANTH VENKATA, SAN RAMON, CA (US); JACQUES VIGEANT, FORT LAUDERDALE, FL (US)

(21) Appl. No.: 17/030,149

(22) Filed: Sep. 23, 2020

Related U.S. Application Data
(63) Continuation of application No. 13/100,255, filed on May 3, 2011.
(60) Provisional application No. 61/349,710, filed on May 28, 2010.

(51) Int. Cl. G06F 16/25

(52) U.S. Cl. CPC G06F 16/254; G06F 16/283

(57) ABSTRACT

A business intelligence (BI) server maintains a plurality of metadata objects to support the extract, transform and load (ETL) processes. These metadata objects includes a transparent view object, which takes a joined set of source tables and represents a data shape of the joined set of source tables using a transformation, and a ETL mapping association object that maps the transformation contained in the transparent view object to a target table. The BI server can then orchestrate the movement of data from source systems into the target data warehouses in a source and target system agnostic way.

### CLAIM OF PRIORITY

This application is a continuation of U.S. patent application Ser. No. 13/100,255, filed May 3, 2011 entitled “SYSTEM AND METHOD FOR ENABLING EXTRACT TRANSFORM AND LOAD PROCESSES IN A BUSINESS INTELLIGENCE SERVER”, and which application claims the benefit of priority to U.S. Provisional Patent Application No. 61/349,710, entitled “SYSTEM AND METHOD FOR ENABLING EXTRACT TRANSFORM AND LOAD (ETL) PROCESSES IN A BUSINESS INTELLIGENCE (BI) SERVER” filed May 28, 2010, which applications are hereby incorporated by reference in its entirety.

### CROSS REFERENCE TO RELATED APPLICATIONS

This application is related to the following applications which are incorporated herein by reference:

U.S. Patent Application Ser. No. 12/711,269, entitled “GENERATION OF STAR SCHEMAS FROM SNOWFLAKE SCHEMAS CONTAINING A LARGE NUMBER OF DIMENSIONS” by Samir Satpathy, filed on Feb. 24, 2010;

U.S. patent application Ser. No. 13/100,245, entitled “SYSTEM AND METHOD FOR PROVIDING DATA FLEXIBILITY IN A BUSINESS INTELLIGENCE SERVER USING AN ADMINISTRATION TOOL” by Raghuram Venkatasubramanian et al., filed on May 3, 2011;

U.S. patent application Ser. No. 13/100,248, entitled “SYSTEM AND METHOD FOR SPECIFYING METADATA EXTENSION INPUT FOR EXTENDING A DATA WAREHOUSE” by Raghuram Venkatasubramanian et al., filed on May 3, 2011; and

U.S. patent application Ser. No. 13/100,249 entitled “SYSTEM AND METHOD FOR SUPPORTING DATA WAREHOUSE METADATA EXTENSION USING AN EXTENDER” by Raghuram Venkatasubramanian et al., filed May 3, 2011.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

The present invention generally relates to data warehouses and business intelligence, and particularly to supporting extract, transform, and load metadata in a business intelligence server.

### BACKGROUND

In the context of computer software, and particularly computer databases, the term “data warehouse” is generally used to refer to a unified data repository for all customer-centric data. A data warehouse environment tends to be quite large. The data stored in the data warehouse can be cleaned, transformed, and catalogued. Such data can be used by business professionals for performing business related operations, such as data mining, online analytical processing, and decision support. Typically, a data warehouse can be associated with extract, transform, and load (ETL) processes and business intelligence tools. Extract, transform, and load (ETL) is a process of extracting data from source systems and bringing it into a data warehouse. Generally, the ETL process includes extracting data from outside sources, transforming the data to fit operational needs, and loading the data into an end target database or data warehouse. A data warehouse environment tends to be very large. As such, designing and maintaining the ETL process is often considered one of the more difficult and resource-intensive portions of a data warehouse project. Many data warehousing projects use ETL tools to manage this process. Some data warehouse builders provide ETL capabilities and take advantage of inherent database abilities. Other data warehouse builders create their own ETL tools and processes, either inside or outside the database. This is the general area that embodiments of the invention are intended to address.

### SUMMARY

In accordance with an embodiment, a business intelligence (BI) server maintains a plurality of metadata objects to support the extract, transform and load (ETL) processes. These metadata objects includes a transparent view object, which takes a joined set of source tables and represents a data shape of the joined set of source tables using a transformation, and a ETL mapping association object that maps the transformation contained in the transparent view object to a target table. The BI server can then orchestrate the movement of data from source systems into the target data warehouses in a source and target system agnostic way.

### BRIEF DESCRIPTION OF THE FIGURES

FIG. 1 illustrates an exemplary view of extract, transform, and load processes in accordance with an embodiment.

FIG. 2 illustrates an exemplary view of mapping multiple source tables to a target table in accordance with an embodiment.

FIG. 3 illustrates an exemplary view of the transforming steps to create a target data model from a source data model in accordance with an embodiment.

FIG. 4 illustrates an exemplary view of a single extract, transform, and load mapping for extract in accordance with an embodiment.

FIG. 5 illustrates an exemplary work flow of implementing an externalized extract, transform, and load mapping user interface in accordance with an embodiment.

FIG. 6 illustrates an exemplary configuration file for an ETL mapping association object in an externalized extract, transform, and load mapping user interface in accordance with an embodiment.

FIG. 7 illustrates an exemplary view of a single extract, transform, and load mapping for pattern based load in accordance with an embodiment.

FIG. 8 illustrates an exemplary view of a single extract, transform, and load mapping for general extract, transform, and load process in accordance with an embodiment.

FIG. 9 illustrates an exemplary view of a single extract, transform, and load mapping for upgrading a dimension table in accordance with an embodiment.

### DETAILED DESCRIPTION

The present invention is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

As described herein, a data warehouse can be used to store critical business information. Business intelligence (BI) applications running on top of the data warehouse can provide powerful tools to the users for managing and operating their business. These BI tools can not only help the users run their day-to-day business, but also help the users make critical tactical, or even long term strategic, business decisions.

There can be different types of BI applications used in the enterprise environment, such as sales, marketing, supply chain, financial, and human resource applications. An application framework, such as ADF, can be used to implement the different types of BI applications. Each BI application can store and use one or more application data objects in its own application data store, outside of the data warehouse.

A BI server can reside between the BI applications and the data warehouse. The BI server allows the BI applications to use high-level analytical queries to scan and analyze large volumes of data in the data warehouse using complex formulas, in order to provide efficient and easy access to information required for business decision making. The BI applications can rely on the BI server to fulfill its analytic requirement.

A data warehouse can be sourced from multiple data source systems associated with the BI applications. As such, a BI server can associate an entity in the target data warehouse with data objects from multiple data sources, by extracting data from the various data sources into a single staging area, where the data conformance is performed before the conformed data can be loaded into the target data warehouse.

Furthermore, when BI applications make changes, or extensions, on the application data objects in application data store. The BI server can propagate the changes and the extensions on the application objects in the application framework to the underlying data warehouse that stores the data in the application objects.

The BI server uses extract, transform, and load (ETL) processes to extract data from the outside data sources, transform the source data to fit operational needs, and load the data into the target data warehouse. ETL metadata can be used to define and manage the ETL processes associated with the data warehouse. Such metadata is essential to the data warehouse and the BI systems on top of the data warehouse. An administration tool on the BI server allows a user to interact with the BI server, and manage the extension process of the underlying data warehouse through metadata.

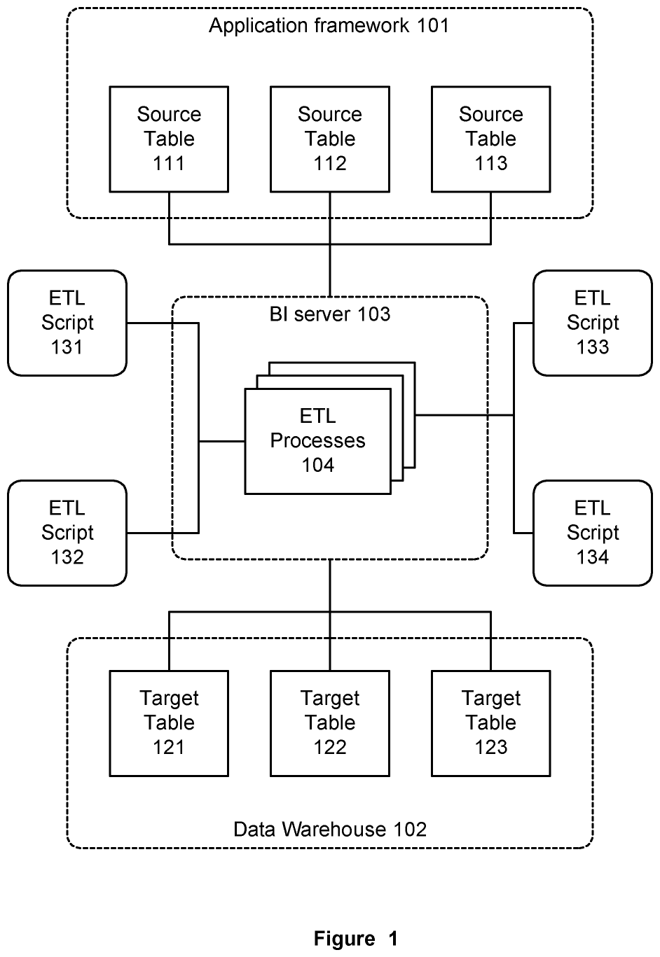

FIG. 1 illustrates an exemplary view of ETL processes in accordance with an embodiment. As shown in FIG. 1, ETL processes 104 allow content builders to associate different data sources in an application framework 101, such as source tables 111, 112, and 113, with different targets in a target data warehouse 102, such as target tables 121, 122 and 123, using various ETL scripts 131, 132, 333, and 134. The number of the scripts can increase accordingly, as new sources and targets are added into the system. Additionally, business logic in the application framework may include multiple duplicative scripts.

In accordance with an embodiment, ETL processes can be based on different types of conceptually independent metadata: such as data transformation logic metadata, data flow metadata, and task execution metadata.

The data transformation logic metadata can specify the data transformations, such as joins between participating entities, expressions etc., to logically construct an entity such as a target table on a target system based on one or more entities from the participating source systems.

The data flow metadata can specify metadata properties and functionalities to allow data to flow through the defined transformation steps. The data flow metadata captures a specific set of properties that are related to ETL runs. One exemplary data flow metadata can specify whether a ETL run is incremental or full; another exemplary data flow metadata can specify whether a table should be joined or not.

The task execution metadata can specify actual execution of the ETL scripts to move data from the various sources to a target. The task execution metadata can analyze the task dependency and generate plans for parallelization.

Other types of ETL metadata can include execution management metadata, project metadata, and scheduling metadata. The execution management metadata comprises different types of metadata related to ETL execution workflow management. The project metadata allows the user to group together and execute a collection of data flows. The scheduling metadata evaluates the supported features and implementation.

In accordance with an embodiment, the project metadata includes set definition that is driven by facts selected by the users for extract. Using the set definition, the system can analyze dependencies and pull in related artifacts that need to participate in the ETL processes, such as base facts, dimensions. The system can exclude and/or include additional target artifacts, and allows a user to persist and maintain a customized set.

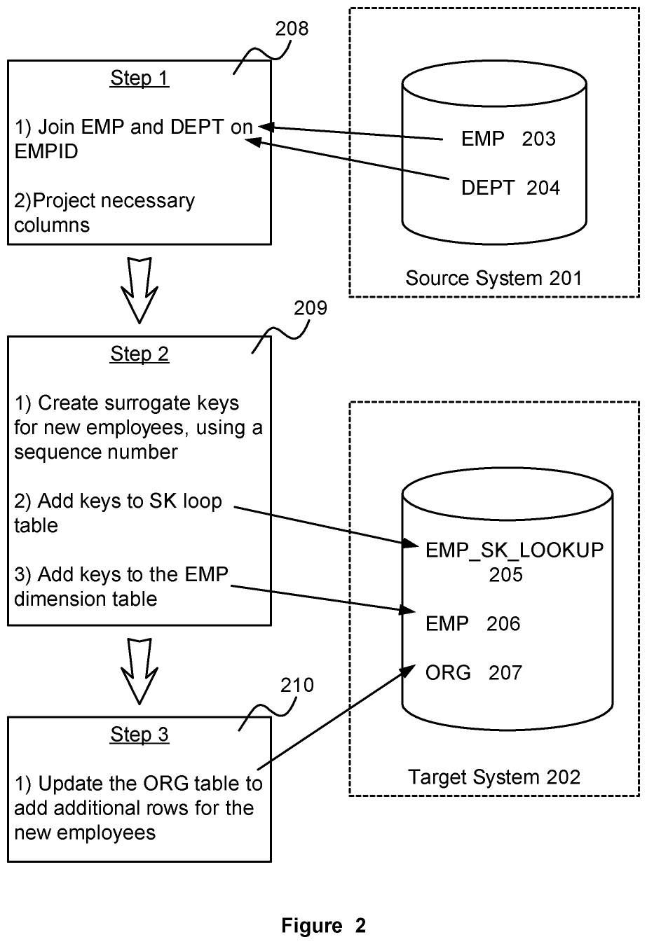

FIG. 2 illustrates an exemplary view of the transforming steps to create a target data model from a source data model in accordance with an embodiment. In the example as shown in FIG. 2, a BI server can use a simple ETL Flow, which includes a plurality of transformation steps, to create a target system 202 from a source system 201. In the example as shown in FIG. 2, the source system includes two tables: an EMP table 203 and a DEPT table 204. The EMP table includes columns such as: ID, Name, Mgrld, Age, Deptld. The DEPT table includes columns such as: ID, Name, Head. The target system includes three tables: an EMP table 205; an ORG table 206; and a CALENDER table 207. The EMP table includes columns such as: EmpSk, ID, Name, DeptName, DeptHead. The ORG table is a fixed ten level table that contains the EmpSk for every employee's mgmt chain. The CALENDER table is a Date level calendar table.

As shown in FIG. 2, the BI server can perform operations on the source system at a first step 208. For example, an operation is to join Table EMP and Table DEPT on EMPld, and another operation is to project necessary columns. Then, the BI server can perform operations on the target system at a second step 209. For example, an operation is to create surrogate keys (SKs) for new employees using a sequence number, another operation is to add rows to the surrogate key (SK) loop table, and a third operation is to add rows to the EMP dimension table. Finally, The BI server updates the ORG table 207 by adding rows for the new employees at step 210.

In accordance with an embodiment, a BI server allows the administrator to capture each of the transformation steps shown in FIG. 2 via ETL data transformation logic metadata objects. The BI server allows users to create a derived physical entity based on other physical entities. The derived physical entity can use application and database (DB) vendor agnostic grammar.

### ETL Data Transformation Logic Metadata

In accordance with an embodiment, a business intelligence (BI) server can use ETL data transformation logic metadata to orchestrate the movement of data from source systems into the target data warehouses in a source and target system agnostic way. The ETL data transformation logic metadata can be structured and declarative metadata to facilitate easy maintenance and improve understandability.

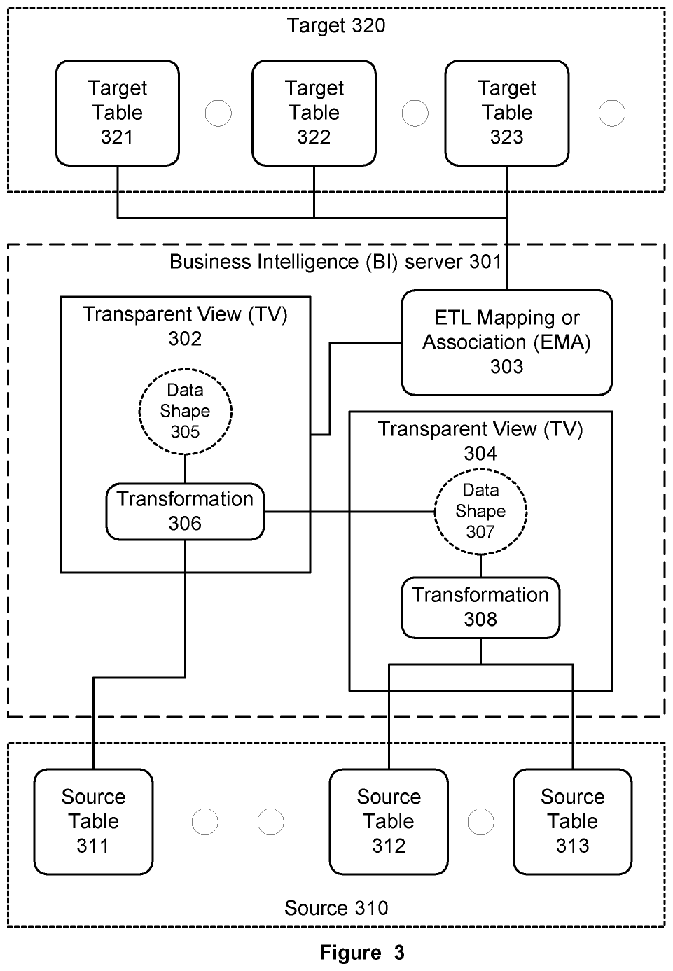

FIG. 3 illustrates an exemplary view of mapping multiple source tables to a target table in accordance with an embodiment. As shown in FIG. 3, the BI server 301 can maintain a plurality of metadata objects to support the ETL processes. These metadata objects include a transparent view (TV) object and an ETL mapping association (EMA) object. The TV object 302 represents a data shape 305 of the joined set of source tables using a transformation 306. The EMA object 303 maps the transformation contained in the TV object to a target table 323. In an embodiment, the target table can be a target staging table in a target data warehouse.

In accordance with an embodiment, the TV objects can be completely database agnostic, and extremely flexible. In an embodiment, a TV object can represent a data shape of multiple different source tables that generates a SQL construct, such as a select physical SQL statement. In another embodiment, the TV objects, which are not execution data structures, can store declarative rules that describing how ETL data transformations happen.

In accordance with an embodiment, the TV objects can be defined in the context of a physical source. Users are able to specify operations such as: joins, expression based derived columns, and filters. In one example, the TV object can be implemented in a similar manner to Logical Table Sources (LTS), which allows an administrator to create a logical table by transforming one or more physical tables from one or more sources.

In accordance with an embodiment, the BI server allows users to span a TV object across multiple databases and tables, so that users can progressively build the data shape by nesting objects within each other. A nested TV object can be joined with other physical layer objects, such as source tables.

In the example as shown in FIG. 3, a high level TV object 302 represent a data shape of several physical source tables, with the help from a nested TV object. Here, the nested TV object 304 is a joined set of two physical source tables 312 and 313. And, the high level TV object is a joined set of a physical source table 311, and the nested TV object.

As shown in FIG. 3, the EMA object can be a one-to-one mapping between a single TV object and a single physical staging table 323. In other embodiments, the user can define multiple ETL mappings in a single EMA object. Each mapping can be associated with a different mapping type or option between the same pair of source TV object and target physical table. In other embodiments, there can be many-to-many mapping relationship, or one-to-many mapping relationship, between the TV objects and the physical tables. Each physical table can be associated with different mappings, and each TV object can be associated with different mappings.

In accordance with an embodiment, a code generator can read the TV objects and the EMA object to generate one or more ETL scripts. In another embodiment, TV objects can participate in complex ETL data transformation process, such as three-way merge project and project extract, since users can select a TV object and easily visualize all source and target links associated with the TV object, from an immediate link to the complete graph.

### ETL Data Flow Metadata

In accordance with an embodiment, ETL data flows can be broken down into several steps. There can be an extract step, which handles source to staging transformations. There can also be a load step, which handles staging to target transformations, and another step for post load data transformations.

In accordance with an embodiment, ETL data flow metadata can be independent of the actual transformation steps. The data flow metadata can capture the operational steps that need to be implemented before or after a transformation step.

The data flow metadata can specify physical structure maintenance. In an embodiment, ETL data flow can split the load operations into update operation for existing rows and insert operation for new rows. The administrators can run a sequence of operations improves performance, since bulk inserts on an indexed structure can be very slow. The sequence of operations can include: 1) ‘Update’ load, 2) drop indices, 3) run the insert statement either via SQL or via a fast load mechanism, and 4) recreate indices.

The data flow metadata can distinguish an incremental load from a full load. In an embodiment, in order to facilitate an incremental load, the source system can have a ‘Last Updated Date’ column. A filter can be added to the query to ensure that only rows updated after a certain point are considered for extraction. The metadata for incremental load enablement, for example the ‘Last Updated Date’ column, can be captured as a metadata property within the transparent view metadata structure. The preference to run either an incremental load or a full load can be defined as a part of the data flow metadata.

The data flow metadata can specify additional data flow properties, such as currencies that a deployment wants to report on. Transactional systems can have two currencies: a local currency and a global currency. The local currency records the transaction in the actual currency that it was exercised under. The global currency is a single currency (For example USD, or EUROs) in which all transaction amounts are recorded. The data flow can convert the global currency to the desired target currency, in order to fulfill the reporting currency conversion requirements. So that, the problem of converting many local currencies to many target currencies is reduced to a simpler problem of converting one global currency to many target currencies. In this example, the currency table registration, which joins between target fact tables and the currency conversion table, can be captured in transparent view metadata. The choice of the actual reporting currencies can be captured and handled within the data flow.

The data flow metadata can also specify partitioned workflows. Some data warehouse implements capabilities for parallelizing the full loads of large fact tables by partitioning the load into multiple parallel loads. In order to achieve such parallelism, users can make multiple copies of the ETL maps, one map for each partition.

In accordance with an embodiment, there can be a clean separation between the data transform logic metadata and ETL data flow metadata. Users can either invoke the same data transform logic via multiple work flows, or invoke the data transform logic via a parameterized ETL workflow, which can be executed in parallel for each set of parameters.

### ETL Task Execution Metadata

In accordance with an embodiment, there can be different approaches to support the ETL execution, such as an ETL code generation approach and a BI Server ETL execution approach. Using the ETL code generation approach, a BI Server can generate the ETL scripts for a desired third party, such as vendors of choice. At runtime, the ETL tool can carry out the ETL execution, with BI Server acted as a data source. The ETL code generation approach allows ETL vendors to implement various optimization techniques that the BI Server may not support, for example, non-SQL fast load and parallel loads. Additionally, the ETL vendors can allow fine grained options, in terms of performance and functionality.

Using the BI Server ETL execution approach, a BI server works as the ETL execution engine. The BI Server can be responsible for interacting with the source and target directly, executing the various transform steps (backed with internal execution capabilities), and load data in the target and build/maintain the related physical artifacts, such as indices etc. The BI Server ETL execution approach eliminates the need to install, deploy and maintain another product and a metadata repository. Every time a user by-passes the BI Server, the user risks to increase the total cost of ownership, since these by-passes needs to be manually patched and upgraded.

In accordance with an embodiment, these two approaches can be used together for expediency and risk mitigation reasons. For example, a BI Server can support code generation for ETL and perform minimum required execution capabilities. The BI server can also provide the extensions required by the content developers to express transforms. The BI Server allows users to select certain target objects and have the ETL scripts generated for these target objects. Users can then have these scripts executed via the ETL vendor's execution engine. The BI System can provide extensibility updates support to these scripts, and the execution management support for these scripts. In an embodiment, the BI System allows the users to edit these scripts manually via the ETL designer's user interface.

### Externalized User Interface (UI)

In accordance with an embodiment, a BI server can use an externalized user interface (UI) to support a variable number of ETL mapping types. Using the externalized UI, the ETL mapping types can be extended without changing the underlying UI implementation software source code. In an embodiment, each ETL mapping type can be defined via XML declarations. Additionally, the BI server can support a set of data manipulation language (DML) options, with each ETL mapping type exposing a subset of the DML options.

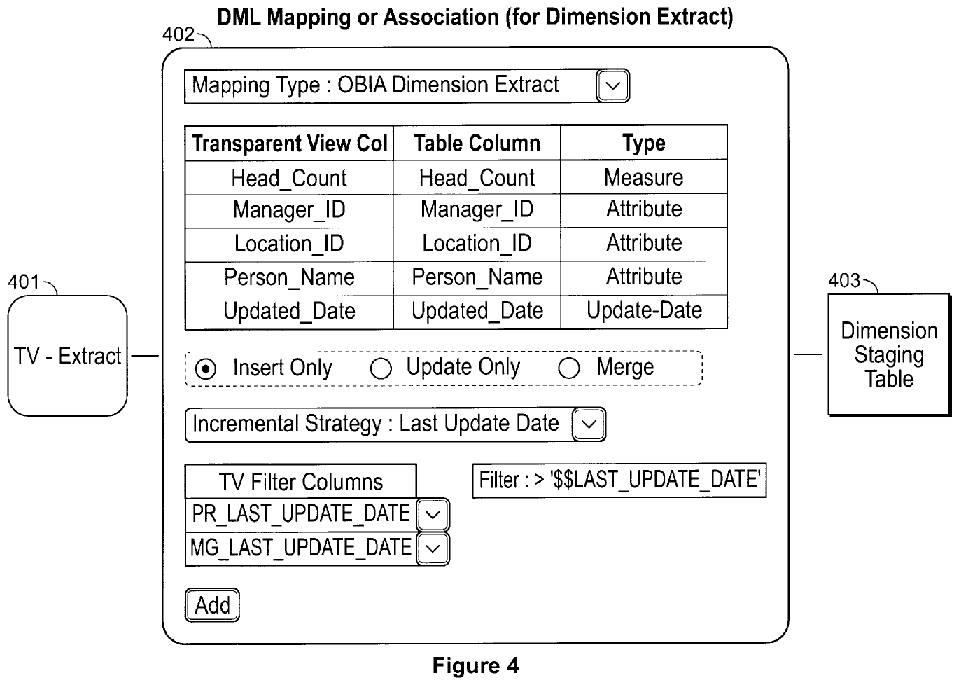

FIG. 4 illustrates an exemplary view of a single ETL mapping for extract in accordance with an embodiment. The exemplary UI for ETL mapping, as shown in FIG. 4, can be constructed dynamically based on the XML declarations, with the associated options stored in the metadata. As shown in FIG. 4, the externalized EMA UI 402 uses a couple of object selector edit boxes and browse buttons to associate the TV objects 401 with the staging table 403. The externalized EMA UI can have a dropdown list for the EMA type, such as Standard Dimension, General ETL etc. The externalized EMA UI can also have a grid for the column mappings. In an embodiment, the number of columns in the grid is a variable depending on the column level options specified in an XML file that defines the EMA UI. Attributes that needs to be shown for each column, such as the column type and SCD2 tracked, etc, can be specified in the XML file, and can be represented as an additional column in the grid.

The following Listing 1 is an exemplary XML file that defines an EMA UI.

Listing 1

<?xml version=“1.0” encoding=“utf-8”?>
<UIOptions>

<MappingTypesSupported>

<Value><![CDATA[obiaStandardDimensionExtract]]></Value>
<Value><![CDATA[obiaStandardFactExtract]]></Value>
<Value><![CDATA[generalETL]]></Value>

</MappingTypesSupported>
<MappintTypeContorls>

<MappingType emaType=“obiaStandardDimensionExtract”>

<OptionDependencies>

<Dependency optionName = “IsSCD” value=“true”>

<Show optionName=“ SCDAlgorithm”/>

</Dependency>
<Dependency optionName = “SCDAlgorithm” value=“SCD2”>

<Show optionName=“ scd2tracked”/>

</Dependency>

</OptionDependencies>
<ColumnlOptions>

| | |
|---|---|
| <Option optionName=“scd2tracked” | controltype=“checkbox” headerText=“SCD2” |

showByDefault=“false” />

| | | |
|---|---|---|
| <Option optionName=“columnType” | controltype=“dropdown” | headerText=“Type” |

showByDefault=“true”>

<ListOfValues>

<Value><![CDATA[Measure]]></Value>
<Value><![CDATA[Dimension]]></Value>
<Value><![CDATA[Key]]></Value>

</ListOfValues>

</Option>

</ColumnlOptions>
<Row>

<col>

| | | |
|---|---|---|
| <Option optionName=“ETLtype” | controlType=“dropdown” | uiLabel=“Choose ETL |

Type ” showByDefault=“true”>

<ListOfValues>

<Value><![CDATA[Insert]]></Value>
<Value><![CDATA[Update]]></Value>
<Value><![CDATA[Merge]]></Value>

</ListOfValues>

</Option>

</col>

</Row>
<Row>

<col>

| | | |
|---|---|---|
| <Option optionName=“IsSCD” | controlType=“checkbox” | uiLabel=“Involves SCDs” |

showByDefault=“true”/>

</col>
<col>

| | | |
|---|---|---|
| <Option optionName=“SCDAlgorithm” | controlType=“editbox” | uiLabel=“SCD |

| Algorithm” | showByDefault=“false”/> |
|---|---|
| | </col> |

</Row>

</MappingType >

</MappintTypeContorls>

</UIOptions>

The following Listing 2 is an exemplary schema associated wit the XML file that defines the EMA UI.

Listing 2

<?xml version=“1.0” encoding=“utf-8”?>
<xs:schema xmlns:xs=“http://www.w3.org/2001/XMLSchema”>

<xs:simpleType name=“controlType_t”>

<xs:restriction base=“xs:string”>

<xs:enumeration value=“DropDown” />
<xs:enumeration value=“CheckBox” />
<xs:enumeration value=“EditBox” />

</xs:restriction>

</xs:simpleType>
<xs:complexType name=“dependency_t”>

<xs:sequence>

<xs:element name=“Show”>

<xs:complexType>

<xs:attribute name=“optionName” type=“xs:string”/>

</xs:complexType>

</xs:element>

</xs:sequence>
<xs:attribute name=“optionName” type=“xs:string”/>
<xs:attribute name=“optionValue” type=“xs:string”/>

</xs:complexType>
<xs:complexType name=“option_t”>

<xs:sequence>

<xs:element name=“ListOfValues” minOccurs=“0” maxOccurs=“1”>

<xs:complexType>

<xs:sequence>

| | |
|---|---|
| <xs:element name=“Value” type=“xs:string” | minOccurs=“1” |

maxOccurs=“unbounded”/>

</xs:sequence>

</xs:complexType>

</xs:element>

</xs:sequence>
<xs:attribute name=“optionName” type=“xs:string”/>
<xs:attribute name=“controlType” type=“controlType_t”/>
<xs:attribute name=“uiLabel” type=“xs:string”/>
<xs:attribute name=“showByDefault” type=“xs:boolean” default=“true”/>

</xs:complexType>
<xs:complexType name=“mappingType_t”>

<xs:sequence>

<xs:element name=“OptionDependencies” minOccurs=“0” maxOccurs=“1”>

<xs:complexType>

<xs:sequence>

<xs:element name=“Dependency” type=“dependency_t” minOccurs=“1”

maxOccurs=“unbounded”/>

</xs:sequence>

</xs:complexType>

</xs:element>
<xs:element name=“ColumnOptions” minOccurs=“0” maxOccurs=“1”>

<xs:complexType>

<xs:sequence>

<xs:element name=“Option” type=“option_t” minOccurs=“1”

maxOccurs=“unbounded”/>

</xs:sequence>

</xs:complexType>

</xs:element>
<xs:element name=“Row” minOccurs=“0” maxOccurs=“unbounded”>

<xs:complexType>

<xs:sequence>

<xs:element name=“Column” minOccurs=“1” maxOccurs=“unbounded”>

<xs:complexType>

<xs:sequence>

<xs:element name=“Option” type=“option_t” minOccurs=“1” maxOccurs=“1”/>

</xs:sequence>

</xs:complexType>

</xs:element>

</xs:sequence>

</xs:complexType>

</xs:element>

</xs:sequence>
<xs:attribute name=“emaType” type=“xs:string”/>

</xs:complexType>
<xs:element name=“UIOptions”>

<xs:complexType>

<xs:sequence>

<xs:element name=“MappingTypesSupported”>

<xs:complexType>

<xs:sequence>

| | |
|---|---|
| <xs:element name=“Value” type=“xs:string” | minOccurs=“1” |

maxOccurs=“unbounded”/>

</xs:sequence>

</xs:complexType>

</xs:element>
<xs:element name=“MappingTypeContorls”>

<xs:complexType>

<xs:sequence>

| | |
|---|---|
| <xs:element name=“MappingType” type=“mappingType_t” | minOccurs=“1” |

maxOccurs=“unbounded”/>

</xs:sequence>

</xs:complexType>

</xs:element>

</xs:sequence>

</xs:complexType>

</xs:element>

</xs:schema>

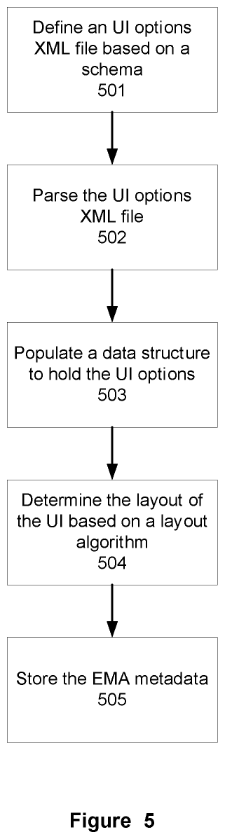

FIG. 5 illustrates an exemplary workflow of implementing an externalized ETL Mapping user interface (UI) in accordance with an embodiment. As shown in FIG. 5, an EMA UI options XML can be defined based on a schema, at step 501. The EMA UI options XML is parsed at step 502. Then, a data structure can be used to hold the UI options at step 503. The system can use a layout algorithm to determine the layout of the externalized ETL Mapping UI at step 504. Finally, the related metadata is stored at step 505.

In accordance with an embodiment, the layout algorithm can first read the dependency graph. The layout algorithm can throw an error for circular dependencies. In an embodiment, the row and column positions can be readjusted based on the options visible in the externalized ETL mapping UI. When the value of an option changes, the algorithm can go through the dependencies again and redo the layout or enable the controls as required.

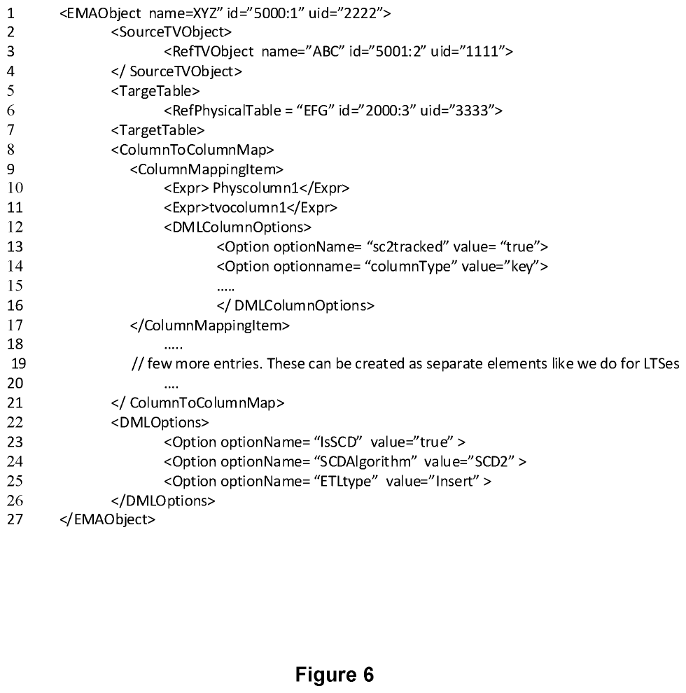

FIG. 6 illustrates an exemplary configuration file for an EMA object in an externalized ETL mapping UI in accordance with an embodiment. In accordance with an embodiment, the exemplary configuration file for an EMA object can be a XUDML file associated with the externalized ETL mapping UI. As shown in FIG. 6, the EMA object (Lines 1-27) includes a source TVO object (Lines 2-4), a target table (Lines 5-7), and a column-to-column mapping relationship (Lines 8-21) between the source and the target. Additionally, the EMA object can include one or more data manipulation language (DML) options (Lines 22-26) that allow the user to configure the data transformation logic.

Based on the same underlying implementation software source code, the BI server can generate different UIs to support different ETL mapping types.

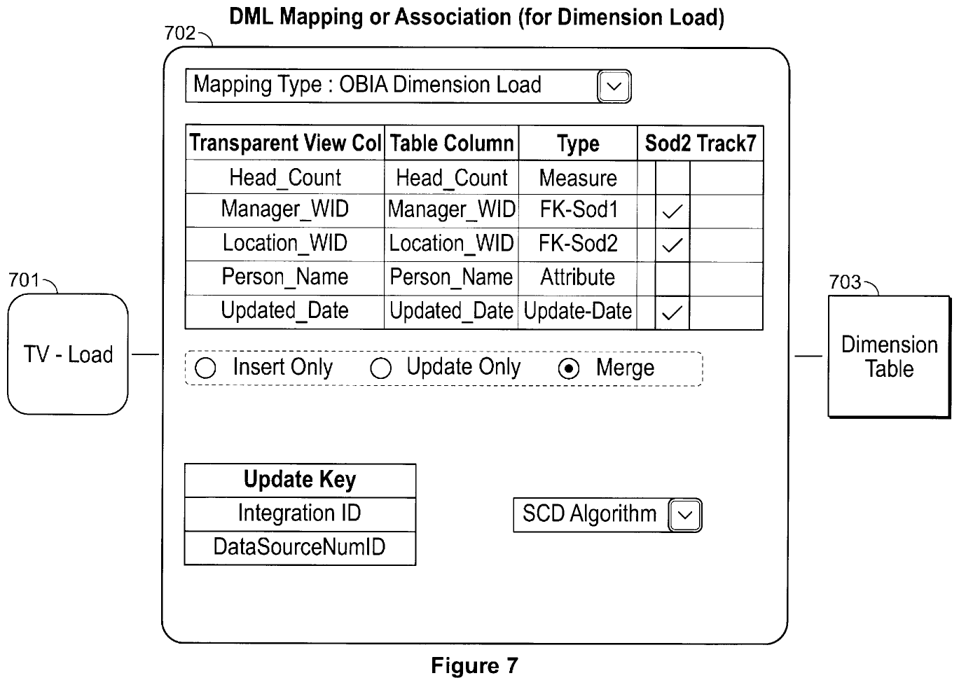

FIG. 7 illustrates an exemplary view of a single ETL mapping for pattern based load in accordance with an embodiment. As shown in FIG. 7, the externalized EMA UI 702 supports a pattern-based load of the TV objects 701 into the dimension table 703.

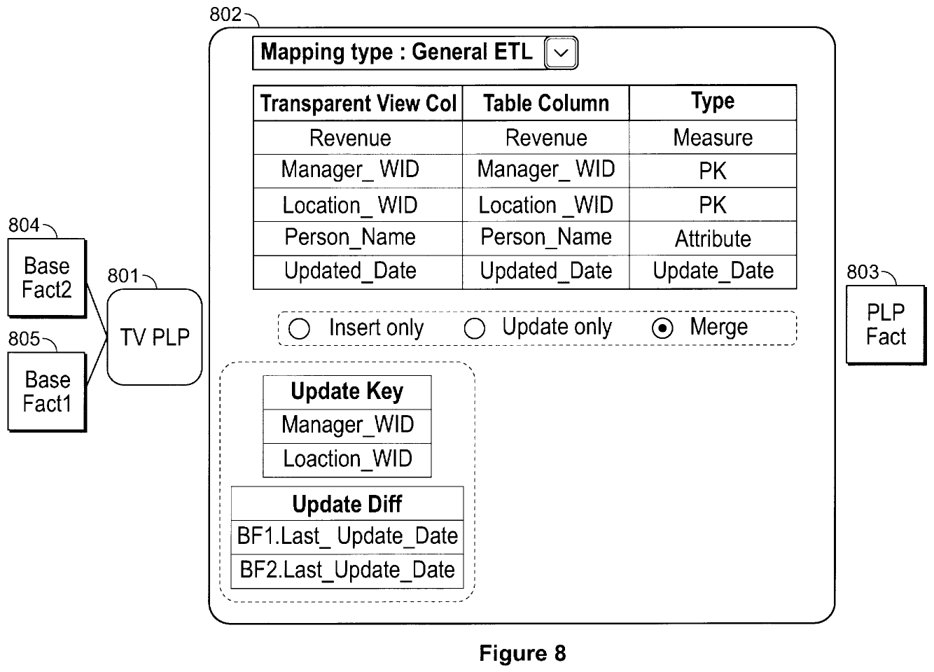

FIG. 8 illustrates an exemplary view of a single ETL mapping for general ETL process in accordance with an embodiment. As shown in FIG. 8, the externalized EMA UI 802 supports general ETL process, such as a post load process (PLP) that transforms a plurality of basic facts 804 and 805 into a PLP fact 803 through a TV object 801.

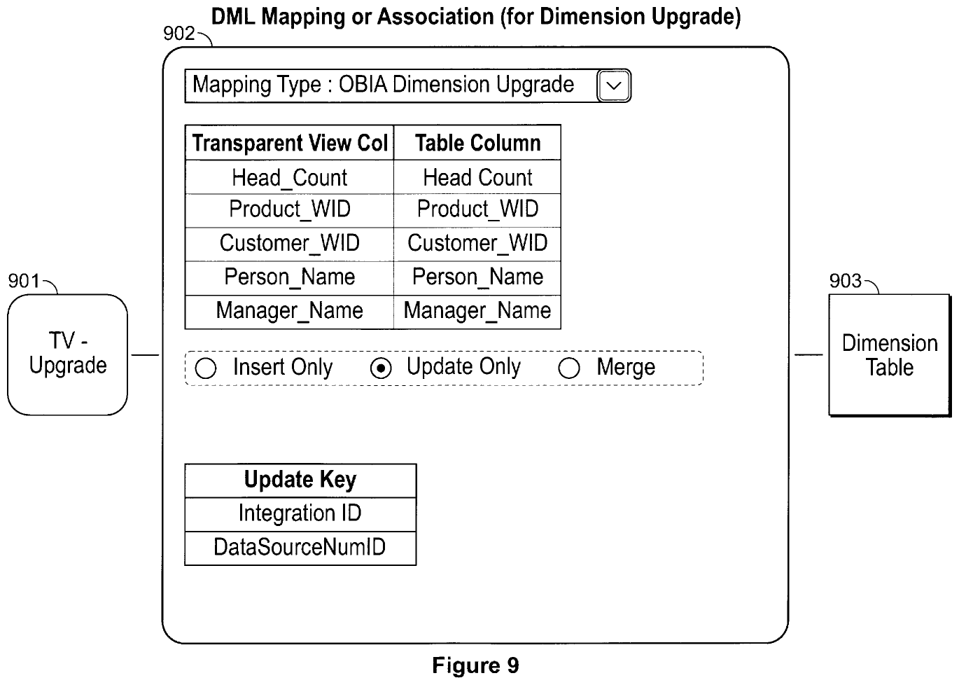

FIG. 9 illustrates an exemplary view of a single ETL mapping for upgrade a dimension table. As shown in FIG. 9, the externalized EMA UI 902 supports upgrading a dimension table 903 defined in a TV object 901.

In accordance with an embodiment, all related ETL objects can be modeled and queried together. A dialog can manage TV objects and EMA objects by filtering objects by target tables, TV objects, and dependencies. Additionally, since each EMA object corresponds to one target table, a physical layer UI can show the TV objects and EMA objects in a tree representation. In one example, the EMA object and the corresponding TV objects can be shortcuts to the actual objects, since they can be replicated across different target tables.

The present invention may be conveniently implemented using a conventional general purpose or a specialized digital computer or microprocessor programmed according to the teachings of the present disclosure. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

The foregoing description of the present invention has been provided for the purposes of illustration and description. It is not intended to be exhaustive or to limit the invention to the precise forms disclosed. Many modifications and variations will be apparent to the practitioner skilled in the art. The code examples given are presented for purposes of illustration. It will be evident that the techniques described herein may be applied using other code languages, and with different code.

The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

1.-13. (canceled)

14. A method for supporting extract, transform and load (ETL) processes, the method comprising:
providing a business intelligence (BI) server executing on one or more microprocessors, wherein the BI server connects source tables on a source system to target tables on a target system;
providing a plurality of data transformation metadata (DTM) objects on the BI server, wherein each of said plurality of DTM objects comprises a data transformation effecting a data shape;
providing a user interface to said BI server;
receiving user input via the user interface to select a plurality of selected DTM objects of the plurality of DTM objects;
receiving user input via the user interface for manipulating the plurality of selected DTM objects in combination, to progressively build a resultant data shape;
reading, with a code generator, the selected DTM objects manipulated by the user in combinations to progressively build the resultant data shape, and an ETL mapping association (EMA) object, and in response thereto generating, by the code generator, ETL scripts;
executing the ETL scripts to move data from the source system to the target system by:
extracting the data from the source tables of the source system;
transforming the extracted data; and
loading the transformed data into the target tables of the target system.

15. (canceled)

16. The method of claim 14, wherein providing the user interface further comprises:
providing a schema that defines data manipulation language (DML) options dynamically generated and displayed in the user interface based on a mapping type selected from the plurality of mapping types;
wherein the DML options allow the user to configure the data transformation logic of the plurality of DTM object via the EMA object; and
wherein, upon selection of the mapping type and DML options associated with the mapping type:
the XML file is parsed,
the EMA object is configured, and
a data structure is populated with the user interface options.

17. The method of claim 14, wherein:
the user interface is configured using an XML file, wherein the XML file can be parsed into a data structure that can be used to layout the user interface for the ETL mapping association object based on a layout algorithm.

18. The method of claim 14, further comprising:
receiving user input via the user interface selecting a selected DTM object of the plurality of selected DTM objects and displaying all source and target links associated with the selected DTM object, from an immediate link to a complete graph.

19. The method of claim 14, wherein receiving user input via the user interface for manipulating the plurality of selected DTM objects in combination, to progressively build a resultant data shape, comprises:
receiving user input specifying one or more operation selected from joins, expression-based derived columns, and filters.

20. The method of claim 14, wherein receiving user input via the user interface for manipulating the plurality of selected DTM objects in combination, to progressively build a resultant data shape, comprises:
receiving user input specifying that a selected DTM object spans across multiple databases and tables.

21. The method of claim 14, wherein the ETL mapping association (EMA) object maps the resultant data shape to the target tables on the target system.

22. The method of claim 14, wherein receiving user input via the user interface for manipulating the plurality of selected DTM objects in combination, to progressively build a resultant data shape, comprises:
nesting at least one selected DTM object in at least one other selected DTM object.

23. The method of claim 22, wherein:
wherein said nesting of at least one selected DTM object in at least one other selected DTM object enables i) reuse of transparent view objects in different combinations to progressively build a data shape, and ii) the second DTM object to span the first and second databases, wherein the second DTM object is agnostic of the first and second databases by the second data shape representation and the second data transformation logic.

24. The method of claim 14, wherein:
a first selected DTM object of the plurality of selected DTM objects selected using the user interface, defines first data transformation logic mapping first physical layer objects into a first logical layer, wherein the first DTM object comprises declarative statements for projecting columns derived from a first set of said source tables into the first logical layer, the first set of said source tables being joined using the first data transformation logic.

25. The method of claim 24, wherein:
a second selected DTM object of the plurality of selected DTM objects selected using the user interface, defines second data transformation logic mapping second physical layer objects into a second logical layer, wherein the second DTM object comprises declarative statements for projecting columns derived from a second set of said source tables into the second logical layer, the second set of said source tables being joined using the second data transformation logic.

26. The method of claim 25, wherein receiving user input via the user interface for manipulating the plurality of selected DTM objects in combination, to progressively build a resultant data shape, comprises:
receiving user input via the user interface for nesting the first DTM object the second DTM object so as to be contained within the second DTM object so that the first set of said source tables directly accessed via the first DTM object are accessible via the second DTM object.

27. A system for supporting extract, transform and load (ETL) processes, the method comprising:
a computer having a one or more microprocessors, and a business intelligence (BI) server executing thereon, wherein the BI server connects source tables on a source system to target tables on a target system;
a plurality of transparent view (DTM) objects on the BI server, wherein said plurality of DTM objects each comprise a data shape using a data transformation;
a user interface to the business server that is configured to:
receive user input via the user interface to select a plurality of selected DTM objects of the plurality of DTM objects; and
receive user input via the user interface for manipulating the plurality of selected DTM objects in combinations to progressively build a resultant data shape;
a code generator that reads the selected DTM objects manipulated by the user in combination to progressively build the resultant data shape and an ETL mapping association (EMA) object, and in response thereto generates ETL scripts;
wherein the system executes the ETL scripts to move data from the source system to the target system by:
extracting the data from the source tables of the source system;
transforming the extracted data; and
loading the transformed data into the target tables of the target system.

28. The system of claim 27, wherein further comprising:
a schema that defines data manipulation language (DML) options dynamically generated and displayed in the user interface based on a mapping type selected from the plurality of mapping types;
wherein the DML options allow the user to configure the data transformation logic of the plurality of DTM objects via the EMA object; and
wherein, upon selection of the mapping type and DML options associated with the mapping type:
the XML file is parsed,
the EMA object is configured, and
a data structure is populated with the user interface options.

29. The system of claim 27, further comprising:
an XML file wherein the XML file can be parsed into a data structure that can be used to layout the user interface for the ETL mapping association object based on a layout algorithm; and
wherein the user interface is configured using an XML file.

30. The system of claim 27, wherein the user interface is further configured to:
receive user input selecting a selected DTM object of the plurality of selected DTM objects and display all source and target links associated with the selected DTM object, from an immediate link to a complete graph.

31. The system of claim 27, wherein the user interface is further configured to:
receive user input specifying one or more operation selected from joins, expression-based derived columns, and filters;
receive user input specifying that a selected DTM object spans across multiple databases and tables; and
receive user input via the user interface to nest at least one selected DTM object in at least one other selected DTM object to build a resultant data shape.

32. The system of claim 27, wherein the ETL mapping association (EMA) object maps the resultant data shape to the target tables on the target system.

33. The system of claim 27, wherein the user interface is further configured to:
receive user input via the user interface to nest at least one selected DTM object in at least one other selected DTM object to build a resultant data shape; and
wherein said nesting of at least one selected DTM object in at least one other selected DTM object enables i) reuse of transparent view objects in different combinations to progressively build a data shape, and ii) the second DTM object to span the first and second databases, wherein the second DTM object is agnostic of the first and second databases by the second data shape representation and the second data transformation logic, and

34. A non-transitory computer-readable storage medium having instructions stored thereon for supporting extract, transform and load (ETL) processes, which instructions, when executed, cause a system executing on one or more microprocessors to perform steps comprising:
providing a business intelligence (BI) server, wherein the BI server connects source tables on a source system to target tables on a target system;
providing a plurality of data transformation metadata (DTM) objects on the BI server, wherein each of said plurality of DTM objects comprises a data transformation effecting a data shape;
providing a user interface to said BI server;
receiving user input via the user interface to select a plurality of selected DTM objects of the plurality of DTM objects;
receiving user input via the user interface for manipulating the plurality of selected DTM objects in combination, to progressively build a resultant data shape;
reading, with a code generator, the selected DTM objects manipulated by the user in combinations to progressively build the resultant data shape, and an ETL mapping association (EMA) object, and in response thereto generating, by the code generator, ETL scripts;
executing the ETL scripts to move data from the source system to the target system by:
extracting the data from the source tables of the source system;
transforming the extracted data; and
loading the transformed data into the target tables of the target system.
